(19) United States
(12) Patent Application Publication
(10) Pub. No.: US 2010/0302166 A1
(43) Pub. Date: Dec. 2, 2010

(54) Keypad with Integrated Alphanumeric Display

(75) Inventor: Zengjian Zhang, Beijing (CN)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/552,463

(22) Filed: Sep. 2, 2009

(30) Foreign Application Priority Data
May 27, 2009 (CN) 200910159510.2

(51) Int. Cl. G06F 3/02

(52) U.S. Cl. 345/169

(57) ABSTRACT

A mobile communication device includes a keypad having an integrated display for displaying alphanumeric information. The mobile communication device includes a housing. A keypad including a plurality of keys is disposed on a front surface of said housing. A plurality of light elements are arranged to emit light through spaces bordering the keys of the keypad. The light elements collectively form a segmented display for displaying alphanumeric characters. A controller operatively connected to the light elements controls the light elements to display alphanumeric information.

### RELATED APPLICATION

This application claims the benefit of Chinese application number 200910159510.2, filed on May 27, 2009, which is incorporated herein by reference.

### BACKGROUND

The present invention relates generally to keypads for electronic devices and, more particularly, to a keypad for electronic devices with an integrated alphanumeric display.

Most cellular telephones, as well as other types of electronic devices, include a keypad and a display to facilitate user interaction with the device. When the cellular telephone is not in use, the display can be used to display the current date and time. Many people now use cell phones, rather than watches, to check the time of day.

Using a cell phone display to display the time of day has some disadvantages. First, most cell phones have limited battery power and using the display to display the current date and time consumes power. Also, the displays on many cell phones, such as flip phones and slide phones, are frequently covered when the cell phone is not in use. Therefore, the user must open the cell phone in order to check the time.

Because many people rely on cell phones as the primary means for checking time, there is a need to improve the display of the date and time on a cellular telephone and other portable electronic devices to reduce power consumption and make it easier for consumers to check the time.

### SUMMARY

The present invention provides a method and apparatus for displaying the current date and time, or other alphanumeric information, to a user of a cellular telephone or other electronic device. The present invention is useful in cellular telephones and other electronic devices having a keypad. In general terms, the invention comprises a segmented LED display that is integrated with the keypad of the cellular telephone or other electronic device. The integrated LED display comprises a plurality of light elements disposed to emit light from the spaces bordering the keys of the keypad. A light controller controls the individual light segments to output alphanumeric information to the user. Thus, the same area used for the keypad can also be used as a digital clock or alphanumeric display.

### BRIEF DESCRIPTION OF THE DRAWINGS

FIG. 1 is a perspective view of an exemplary cellular telephone.

FIG. 2 illustrates a keypad for a cellular telephone with an integrated LED display.

FIG. 3 is a section view of an exemplary keypad with an integrated LED display according to a first embodiment.

FIG. 4 is a section view of another exemplary keypad with an integrated LED display according to a second embodiment

FIG. 5 is a functional block diagram illustrating a display controller for controlling the integrated LED display.

### DETAILED DESCRIPTION

Referring now to the drawings, an exemplary embodiment of the present invention is shown. The invention relates to an electronic device having a keypad with an integrated LED display. The electronic device may, for example, comprise a cellular telephone, smart phone, personal digital assistant, laptop computer, or other type of electronic device including a keypad and display. The exemplary embodiment of the invention described below comprises a cellular phone indicated generally by the numeral 10. However, those skilled in the art will appreciate that the present invention is useful in a wide variety of electronic devices.

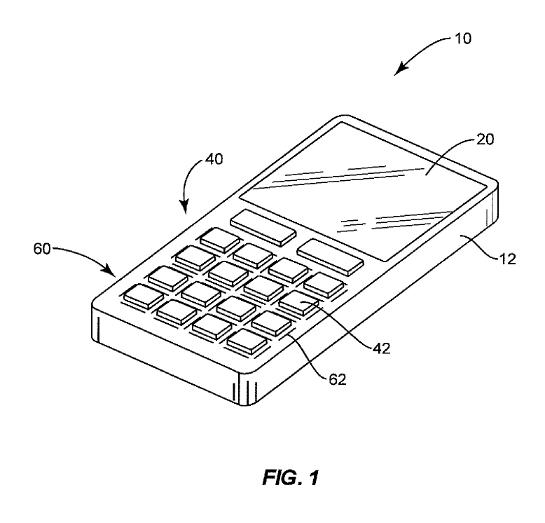

FIG. 1 shows a cellular phone 10 according to one embodiment of the present invention. Cellular phone 10 comprises a housing 12 that contains the electronic components necessary for transmitting and receiving signals. The cellular phone 10 also includes display 20 and keypad 40 to enable user interaction with the cellular telephone 10. Display 20 renders visual information for viewing by a user. The display 20 may comprise, for example, a liquid crystal display. The keypad 40 comprises a numeric having a plurality of keys 42. Display 20 and keypad 40 are disposed on the housing 12 with the keypad 40 below the display 20. However, the particular arrangement of the display 20 and keypad 40 is not material. Thus, the present invention is not limited to the illustrated arrangement.

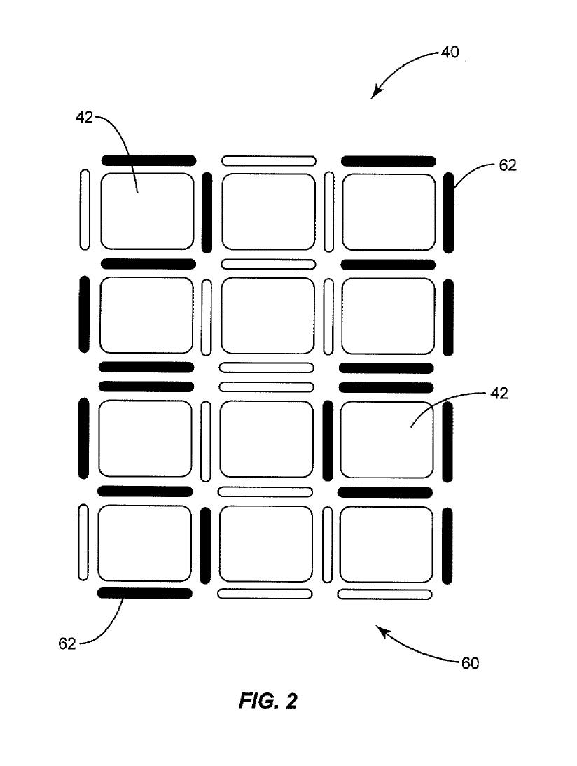

In a conventional cellular telephone, information such as the current date and time is displayed to the user on the display 20. The present invention provides an alternate means of displaying the current date, time, and/or other alphanumeric information to the user. Referring to FIG. 2, keypad 40 includes an integrated LED display 60. LED display 60 comprises a plurality of light elements 62 arranged to emit light from spaces bordering the keys 42 of the keypad 40. The light elements 62 collectively form a segmented, LED display 60 for displaying alphanumeric characters. The LED display 60 can display any type of alphanumeric information. For example, LED display 60 can be used to display the date and/or time of day, biometric data such as pulse rate or blood pressure levels, or ambient conditions such as the current temperature or barometric pressure. If cellular telephone 10 includes a pedometer (not shown), the distance or count generated by the pedometer may be output to the LED display 60.

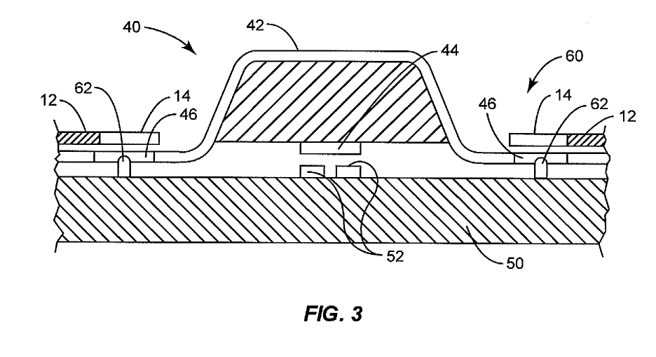

FIG. 3 provides a section view of an exemplary keypad assembly with an integrated LED display 60. The keypad assembly comprises a flexible keypad 40 having a plurality of keys 42 formed thereon. Keypad 40 overlies a printed circuit board 50 having contact pads 52 on an upper surface thereof. The keys 42 of the keypad 40 align with a corresponding set of contact pads 52 on the printed circuit board 50. In the exemplary embodiment shown in FIG. 3, each key 42 includes an electrically conductive element 44. When a key 42 is pressed, the conductive element 44 makes contact with a corresponding contact pad 52 on the printed circuit board 50 to generate an electrical signal that can be detected by a conventional keypad controller (not shown).

The integrated display 60 comprises a plurality of light elements 62 that are surface mounted to the upper surface of the printed circuit board 50. While described herein as an LED display 60 with LED light elements 62, it will be appreciated that any type of light elements 62 may be used for the integrated display 60. The light elements 62 are elongated and disposed along the sides of the keys 42 to form a segmented LED display 60 that is similar to the display of a digital clock. The light elements 62 emit light through slots 46 in the keypad 42. The light emitted by the light elements 62 passes through respective lenses 14 on the housing 12, which are disposed, adjacent the keys 42 of the keypad 40. The light elements 62 and lenses 14 are located in the spaces bordering the keys, and are arranged to function as a segmented display 60.

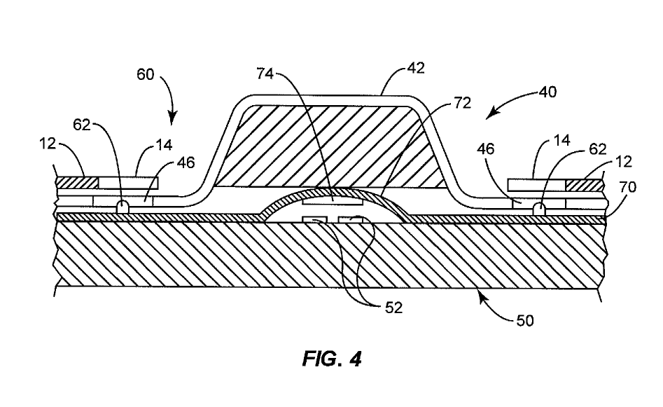

FIG. 4 illustrates another exemplary keypad assembly with an integrated LED display 60. In this embodiment, a flex circuit 70 having a plurality of raised domes 72 is interposed between the flexible keypad 40 and the circuit board 50. Each dome 72 aligns with the corresponding key 42 on the keypad 40. The domes 72 provide a tactile feedback to the user when a key 42 is fully pressed. Each of the raised domes 72 has an electrically conductive element 74 that aligns with contact pads 52 on the printed circuit board 50. When a key 42 is pressed, the contact element 74 of the dome 72 makes contact with a corresponding contact pad 52 on the printed circuit board 50 to generate an electrical signal that can be detected by a conventional keypad controller (not shown).

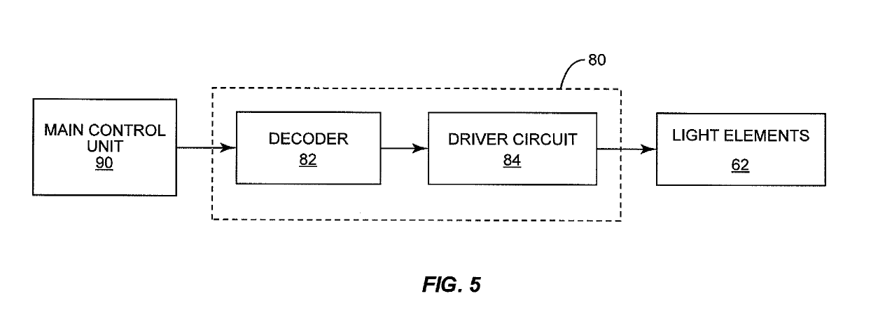

FIG. 5 illustrates a controller for controlling the segmented LED display 60. Information for display is output from a main control unit 90 to a light controller 80. Light controller 80 includes a decoder 82 that converts the alphanumeric characters output from the main control unit into control signals for controlling the individual light elements 62 of the LED display 60. Decoder 82 may comprise a conventional 7-digit decoder. The control signals output from the decoder 82 are supplied to an LED driver circuit 84, which generates drive signals to illuminate the light elements 62 responsive to the control signals from the decoder 82.

The present invention provides an alternative method and apparatus for displaying alphanumeric information, such as the date and time using a segmented display 60 that is integrated with a keypad 40. The LED display 60 consumes less power than would a conventional LCD display. Also, the LED display 60 can be seen even in some electronic devices where the main LCD display 20 is covered, turned off, or in sleep mode. These advantages are realized without any additional space requirements, since the light emits through the gaps between the keys 42 of the keypad 40.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A mobile communication device comprising:
a housing;
a keypad disposed on a front surface of said housing, said keypad including a plurality of keys;
a plurality of light elements disposed to emit light through spaces bordering the keys of the keypad, said plurality of light elements forming a segmented display for displaying alphanumeric characters; and
a controller operatively connected to said light elements to control said light elements to display alphanumeric information.

2. The mobile communication device of claim 1 wherein said light elements comprise light emitting diodes.

3. The mobile communication device of claim 1 wherein said light elements are mounted to a flex circuit underlying said keypad and having raised domes.

4. The mobile communication device of claim 1 wherein said light elements are mounted to a printed circuit board underlying said keypad.

5. The mobile communication device of claim 1 wherein said keypad comprises a flexible pad having keys formed therein.

6. The mobile communication device of claim 5 wherein said keypad includes a plurality of slots arranged to allow light from said light elements to pass through said keypad.

7. The mobile communication device of claim 1 wherein said housing includes a plurality of lenses bordering the keys of the keypad for transmitting the light emitted by the light elements.
